(19) United States
(12) Patent Application Publication
(10) Pub. No.: US 2026/0350116 A1
(43) Pub. Date: Nov. 5, 2026

(54) Mechanism for Accessing Spectral Similarity

(71) Applicant: THE MITRE CORPORATION, McLean, VA (US)

(72) Inventors: Adrian MARIANO, Vienna, VA (US); James F. CAPO, Arlington, VA (US)

(73) Assignee: THE MITRE CORPORATION, McLean, VA (US)

(21) Appl. No.: 18/775,677

(22) Filed: Jul. 17, 2024

Related U.S. Application Data
(60) Provisional application No. 63/557,381, filed on Feb. 23, 2024.

(51) Int. Cl. G06F 18/22; G06F 18/15; G06F 18/2131

(52) U.S. Cl. CPC G06F 18/22; G06F 18/15; G06F 18/2131

(57) ABSTRACT

Disclosed herein are system, apparatus, article of manufacture, method and/or computer program product embodiments, and/or combinations and sub-combinations thereof, for accessing spectral similarity. An example embodiment may compute the wavelet transform. Then it may extract spectral features and their strength values from the wavelet transform data. The embodiment may then compute an edit distance (e.g., a cost to align two sets of features). The embodiment may then normalize the costs. For example, the embodiment may normalize the costs using count normalization or maximum cost. The embodiment may then convert the resulting costs to a number. For example, the embodiment may convert the resulting costs to a number using L₂-norm. The embodiment may then optionally construct and/or plot a spectral feature disagreement plot.

### CROSS REFERENCE TO RELATED APPLICATIONS

This application claims the benefit of provisional U.S. Patent Application No. 63/557,381, filed Feb. 23, 2024, titled “Mechanism for Accessing Spectral Similarity,” which is hereby incorporated by reference in its entirety.

### STATEMENT REGARDING FEDERALLY SPONSORED RESEARCH AND DEVELOPMENT

Statement under MPEP 310. This invention was made with government support under Contract No. W15P7T-13-C-A802 awarded by Department of the Army Materiel Command Communications Electronics Command. The government has certain rights in the invention.

### FIELD

This disclosure is generally directed to spectroscopy, and more particularly to accessing spectral similarity.

### BACKGROUND

Spectral similarity between two spectral data is difficult to access. This is because accessing the similarity between spectral features of the data requires extracting reliable spectral features. Even after extracting the reliable spectral features from their spectra, accessing the similarity of spectral features relies heavily on aligning the key spectral features. Either a failure to extract reliable spectral features or an improper alignment of the spectral features can result in a corrupted estimate of the spectral feature similarity between the two spectral data.

### BRIEF DESCRIPTION OF THE DRAWINGS

The accompanying drawings are incorporated herein and form a part of the specification.

FIG. 1 is a block diagram of a spectral similarity measuring system, according to some embodiments.

FIG. 2 is a block diagram of a system engine, according to some embodiments.

FIG. 3 is a flowchart illustrating a process for accessing spectral data similarity between two spectral data, according to some embodiments.

FIG. 4A is an example of a discrete Haar wavelet at scales 7 and 8, according to some embodiments.

FIG. 4B is an example of a discrete centered Haar wavelet at scales 7 and 8, according to some embodiments.

FIG. 5 is an example of a discrete Mexican hat wavelet at scale 8, according to some embodiments.

FIG. 6 is an example of peakfind-cr, according to some embodiments.

FIG. 7 is an example of peakinflection, according to some embodiments.

FIG. 8 is an example illustrating a feature alignment example between two spectral features, according to some embodiments.

FIG. 9 is an example of constructing cumulative band weighting curve, according to some embodiments.

FIG. 10 is an example of a spectral feature disagreement plot, according to some embodiments.

FIG. 11 is an example of receiver operating characteristic (ROC) curves with free insertions, according to some embodiments.

FIG. 12 is an example of ROC curves without free insertions, according to some embodiments.

FIG. 13 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for accessing a spectral data similarity between spectral data.

Accessing the spectral data similarity between spectral data is valuable and important for spectral data analysis. When analyzing spectral data, conventional approaches often rely on the shape of the spectrum, making some narrow spectral features hard to identify because these narrow features are typically dominated by the shape of the spectrum and hence difficult to extract. To solve these technical problems and obtain a proper access of the feature similarity, embodiments herein use a feature extraction method that locates spectral features and extracts their characteristics.

Embodiments described herein are directed to a computer-implemented method to access a spectral data similarity between two spectral data through feature edit distance. For example, the feature edit distance can handle spectral similarity between spectral data of different lengths and/or at different scales. The feature edit distance can also capture small changes between two spectral data, making the similarity measurement mechanism more robust. The feature edit distance calculation may also consider the weight or importance of a spectral feature and their location alignments, making the feature edit distance robust to the spectral feature noise or outliers. Compared with using reference approaches including but not limited to Spectral Fit to access the spectral data similarity, the feature edit distance can provide superior measurement accuracy while attaining a fairly efficient computational complexity. Therefore, based on the aforementioned advantages of applying feature edit distance to access the spectral data similarity, embodiments herein can use the feature edit distance to provide superior information about spectral similarity, which furthermore is orthogonal to information provided by shape-based approaches such as Spectral Fit.

In some embodiments, the feature edit distance may be computed using a dynamic programming approach. This approach works by building a table that stores the edit distances between the possible prefixes of the two spectral data. The table is then used to compute the edit distance between the two spectral data themselves. Some embodiments may use a parallel algorithm to compute the edit distance. A parallel algorithm is an algorithm that can be run on multiple processors at the same time. This can significantly speed up the computation of the edit distance for lengthy spectral data input or the transformed data.

In some embodiments, the computer-implemented method may access spectral similarity in hyperspectral imagery. This method can apply to any data context in which the data spectra are compared and the purpose of comparison is alignment of features to access spectral similarity. In some embodiments, the computer-implemented method may access any type of spectroscopy including but not limited to infrared, mass spectroscopy, Raman spectroscopy, ion mobility spectroscopy, and/or any type of numerical data containing narrow features at specific data locations.

In some embodiments, the computer-implemented method may extract features from the spectrum using wavelet transform. As would be appreciated by a person of ordinary skill in the art, embodiments herein may use other methods of extracting features.

In some embodiments, the computer-implemented method may extract the features from the two spectra being compared at multiple scales. The spectral similarity can be evaluated based on the quality of the match between the extracted features at different scales.

In some embodiments, the computer-implemented method may compute an edit distance (e.g., a cost to align two sets of features) and may then normalize the costs, where the normalization may be done to equalize contributions from different scales. For example, some embodiments may normalize the costs using count normalization. Some embodiments may normalize the costs using maximum cost. As would be appreciated by a person of ordinary skill in the art, other approaches may be used to normalize the costs. Some embodiments may convert the resulting costs to a number using L₂-norm. Some embodiments may convert the resulting costs to a number (e.g., feature edit distance score) using various other approaches as would be appreciated by a person of ordinary skill in the art. Some embodiments may optionally plot a disagreement plot by first computing a “band weighting” curve and some may characterize how to weight the bands based on their contribution to the final feature edit distance score.

These features will now be discussed with respect to the corresponding figures.

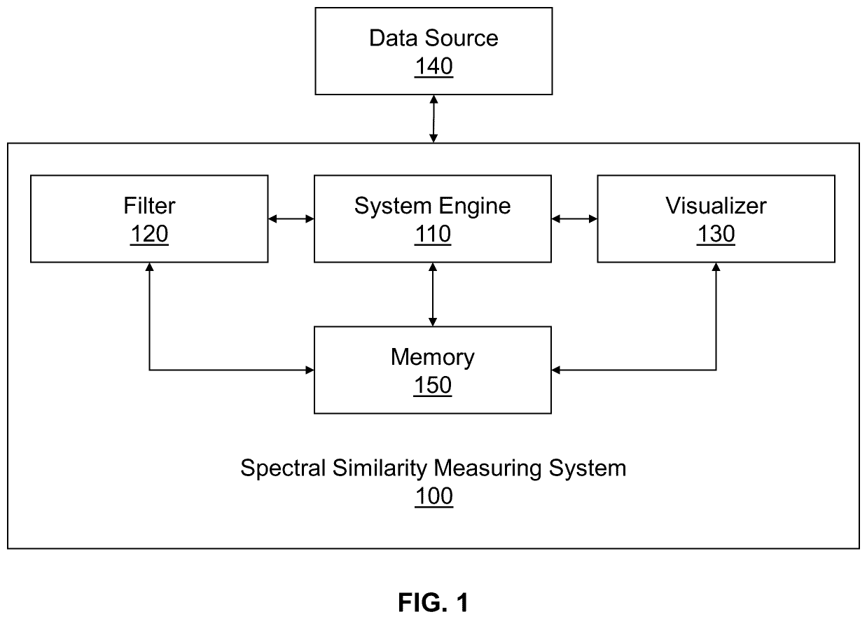

FIG. 1 is a block diagram of a spectral similarity measuring system 100, according to some embodiments. In some embodiments, the spectral similarity measuring system 100 may store data, check dataset compliance, monitor input data, and/or visualize the output data. Checking dataset compliance and/or monitoring input data may allow the spectral similarity measuring system 100 to identify errors related to input data prior to storage. This identification may prevent the storage of erroneous data and/or future reliance on erroneously stored data.

In some embodiments, a spectral similarity measuring system 100 may comprise a system engine 110, a filter 120, a visualizer 130, and a memory 150. System engine 110, filter 120, and/or visualizer 130 may comprise the same hardware and/or may share hardware. For example, the filter 120 may comprise one or more processors, buffers, servers, routers, modems, antennae, and/or circuitry configured to interface with the system engine 110, and/or the memory 150. For example, the system engine 110 may comprise one or more processors, buffers, servers, routers, modems, antennae, and/or circuitry configured to interface with the filter 120, the visualizer 130, and/or the memory 150. For example, the visualizer 130 may comprise one or more processors, buffers, servers, routers, modems, antennae, and/or circuitry configured to interface with the system engine 110 and/or the memory 150.

In some embodiments, data source 140 may not be a source device separate from the spectral similarity measuring system 100. The data source 140 may share hardware with the spectral similarity measuring system 100. For example, data source 140 may internalize spectral similarity measuring system 100 to monitor data processed within the data source 140. In some embodiments, data source 140 may be a separate computing platform, such as but not limited to smartphones, tablet computers, laptop computers, desktop computers, web browsers, and/or other computing devices, apparatuses, systems, or platforms. In some embodiments, data source 140 may transmit information to spectral similarity measuring system 100 either in a wired or wireless manner and may be, for example, the Internet, a Local Area Network, or a Wide Area Network. The transmission may utilize a network protocol, such as, for example, a hypertext transfer protocol (HTTP), a TCP/IP protocol, Ethernet, or an asynchronous transfer mode.

In some embodiments, system engine 110, filter 120, and/or visualizer 130 may communicate with data source 140 via the spectral similarity system 100. The filter 120 may be configured to filter the data received from data source 140. If filter 120 determines that the received data does not comply with the rules, filter 120 may generate a noncompliance alert. Filter 120 may transmit this noncompliance alert to data source 140. The system engine 110 may be configured to process the data filtered from filter 120. If system engine 110 determines that the filtered data does not comply with the rules, system engine 110 may generate a noncompliance alert. System engine 110 may transmit this noncompliance alert to filter 120 and/or data source 140. The visualizer 130 may be configured to visualize the data processed from system engine 110. If visualizer 130 determines that the processed data does not comply with the rules, visualizer 130 may generate a noncompliance alert. Visualizer 130 may transmit this noncompliance alert to system engine 110 and/or data source 140.

In some embodiments, a memory 150 may comprise volatile memory, such as random access memory (RAM), a non-volatile memory, such as a flash memory, and/or a battery backed up RAM, one or more processor registers, or other suitable mechanism for storing data. In some embodiments, filter 120 may be configured to filter the data from data source 140 with the rules generated for filter 120 stored in memory 150. The filter 120 may store the received data in memory 150 before filtering data. If filter 120 determines that the data after filtering complies with the rules determined regarding the data stored in memory 150, filter 120 may store the filtered data in memory 150. If system engine 110 is processing data, filter 120 may buffer the filtered data for processing in a local memory repository of memory 150. In some embodiments, system engine 110 may be configured to process the filtered data from filter 120 with the rules generated for system engine 110 stored in memory 150. The system engine 110 may store the filtered data in memory 150 before processing data. If system engine 110 determines that the data after processing complies with the rules determined regarding the data stored in memory 150, system engine 110 may store the processed data in memory 150. If visualizer 130 is visualizing data, system engine 110 may buffer the processed data for visualizing in a local memory repository of memory 150. In some embodiments, visualizer 130 may be configured to visualize the processed data from system engine 110 with the rules generated for visualizer 130 stored in memory 150. The visualizer 130 may store the processed data in memory 150 before visualizing data. If visualizer 130 determines that the data after visualizing complies with the rules determined regarding the data stored in memory 150, visualizer 130 may store the visualized data in memory 150. The visualizer 130 may also buffer the visualized data in a local memory repository of memory 150.

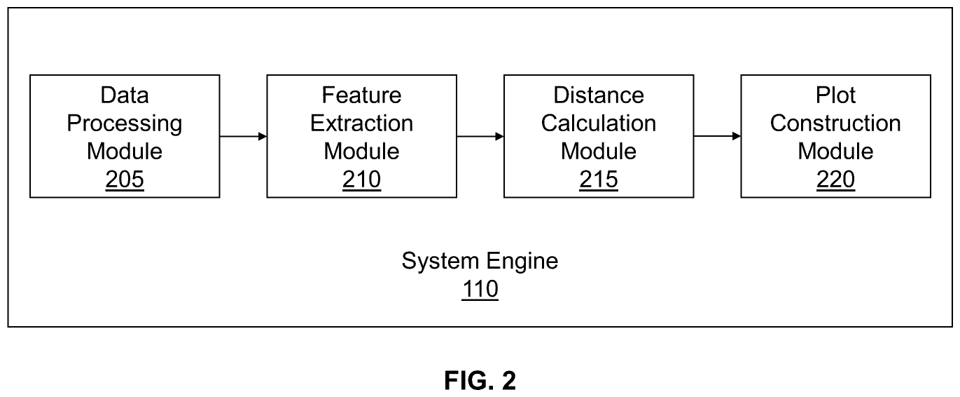

FIG. 2 is a block diagram of a system engine 110, according to some embodiments. In some embodiments, the spectral similarity measuring system 100 may perform data preprocessing and transform on spectral data, extract spectral features and feature strength values, and/or calculate edit distances and the feature edit distance score for the spectral data.

In some embodiments, a system 110 may comprise a data processing module 205, a feature extraction module 210, a distance calculation module 215, and a plot construction module 220. The functional modules described may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the spectral similarity measuring system 100, system engine 110 and/or installed as a removable portion of these systems. Alternative embodiments can perform functional modules, steps, operations, methods, etc. using orderings different than those described herein.

In some embodiments, the data processing module 205 may be configured to preprocess the spectral data filtered from filter 120. This data preprocessing may involve identifying and correcting errors or inconsistencies in the data, including missing values, outliers, and duplicates. Various techniques can be used for data preprocessing including, but not limited to data insertion, data imputation, and/or data removal. The data processing module 205 may be configured to compute a wavelet transform on spectral data after data preprocessing. As would be appreciated by a person of ordinary skill in the art, data processing module 205 may allow other data transforms including, but not limited to, Fourier Transform and Laplace Transform that may transform the spectral data into another domain. The data processing module 205 may also include a data embedding, either using machine learning and/or deep learning or not, to embed the spectral data into a different data representation space. The data processing module 205 may allow normalization of the transform and/or embedded data after applying the data transformation and/or data embedding.

In some embodiments, the feature extraction module 210 may be configured to extract features from the transformed data (e.g., wavelet transform data) computed from data processing module 205. The feature extraction module 210 may allow the spectral features to be extracted for different scales associated with the transform data. The spectral features may refer to variables or attributes of the transform data.

In some embodiments, the distance calculation module 215 may be configured to calculate edit distances based on the extracted spectral features from feature extraction module 210. The distance calculation module 215 may allow calculating edit distances at some scale levels of the extracted spectral features. The edit distance may be defined as the weighted cost of feature insertions, deletions, and/or substitutions, needed to convert one feature set to another. In some embodiments, the distance calculation module 215 may be configured to calculate the normalized version of the edit distances. The calculation module 215 may also be configured to calculate a final feature edit distance score. The final feature edit distance score may be related to a normalized version of the edit distances. The calculation module 215 may allow the score calculation using equal weights but some examples may require the calculation, either based on machine learning or not, to use adaptive weighting schemes.

In some embodiments, the plot construction module 220 may be configured to construct a spectral disagreement plot, construct a band weighting curve, and/or construct a cumulative band weighting plot based on the list of spectral features computed at feature extraction module 210 and their associated feature edit distance score contribution computed at distance calculation module 215. The plot construction module 220 may identify the spectral bands that are responsible for the feature edit distance scores and/or assign the score to the corresponding bands. For example, the plot construction module 220 may use a triangle assembling approach to construct the band weighting curves at different scales, and/or add the curves construct a cumulative band weighting plot. The cumulative band weighting plot may be constructed using a heat map representation.

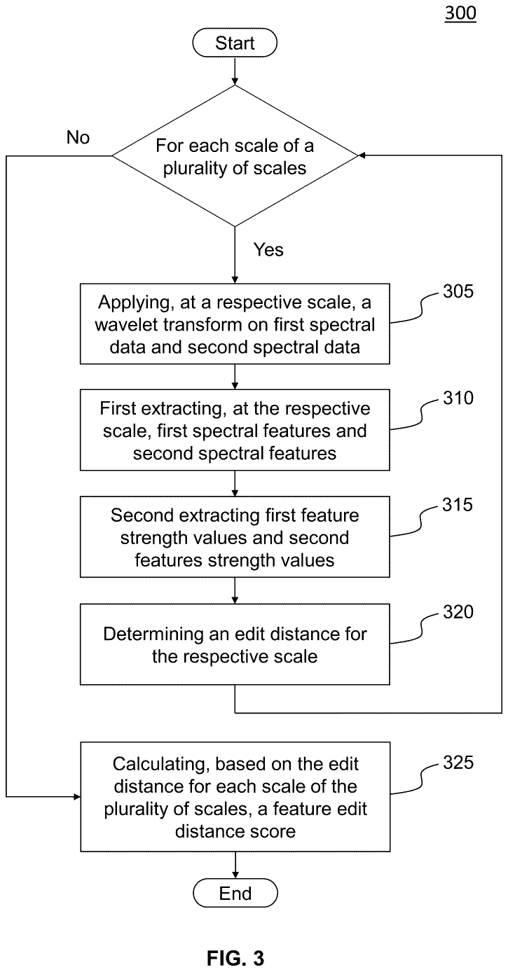

FIG. 3 is a flowchart illustrating a computer-implemented method 300 for accessing spectral data similarity between two spectral data, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1 and/or FIG. 2, but method 300 is not limited to those example embodiments. In some embodiments, method 300 may be performed by system engine 110 that comprises a data processing module 205, a feature extraction module 210, a distance calculation module 215, and a plot construction module 220. The data processing module 205 may preprocess the spectral data to handle missing data in the spectra. For each scale of a plurality of scales, a data processing module 205 may apply, at a respective scale, a wavelet transform on first spectral data and second spectral data at 305. Feature extraction module 210 may first extract, at the respective scale, first spectral features and second spectral features at 310. The feature extraction module 210 may second extract first feature strength values and second features strength values at 315. Distance calculation module 215 may determine an edit distance for the respective scale at 320. Distance calculation module 215 may calculate, based on the edit distance for each scale of the plurality of scales, a feature edit distance score at 325. Plot construction module 220 may construct a spectral disagreement plot and/or construct the cumulative band weighting plot using a heat map representation.

Referring to FIG. 3, method 300 may be performed by the data processing module 205 that receives two spectral data as input. The data input comprises any type of spectral data including, but not limited to, infrared, mass spectroscopy, Raman spectroscopy, ion mobility spectroscopy, and/or any type of numerical data containing narrow features at specific data locations.

Data processing module 205 may determine a first plurality of gaps and a second plurality of gaps associated with the first and the second spectral data, respectively. For example, data processing module 205 may operate on bands to find features that span these gaps. In some embodiments, data processing module 205 can insert a skip sample (e.g., NaNs) to a gap of the first plurality of gaps and to a gap of the second plurality of gaps associated with the first and the second spectral data, respectively. A gap size threshold, g, may be specified. For example, let Δλₘᵢₙ be the minimum wavelength gap between any two bands over the whole spectrum. Data processing module 205 can look for bands whose separation exceeds gΔλₘᵢₙ and insert samples to fill the gaps. For example, if a gap occurs with width w then data processing module 205 can insert round (w/Δλₘᵢₙ)−1 samples, which may approximately match the average band spacing.

In some embodiments, when dealing with small gaps or small irregularities in band spacing, data processing module 205 may perform data interpolation across the gap of the first plurality of gaps and across the gap of the second plurality of gaps associated with the first and the second spectral data, respectively. The interpolation may include but is not limited to liner interpolation, nearest neighbor interpolation, and/or spline interpolation. When interpolation is applied, the spectrum may be resampled to a spacing of Δλₘᵢₙ, using for example, at least one of the built-in interpolation methods available in Python.

At 305, after receiving the two spectral data as input and performing data preprocessing, for each scale of a plurality of scales, data processing module 205 applies, at a respective scale, a wavelet transform on the first spectral data and the second spectral data, thereby obtains first wavelet transform data and second wavelet transform data at the respective scale, respectively. As would be appreciated by a person of ordinary skill in the art, the data processing module 205 may compute other types of data transforms and obtain the transformed data accordingly.

In some embodiments, data processing module 205 may apply a continuous wavelet transform on the two continuous input spectral data at 305, respectively. The continuous wavelets may comprise a Haar wavelet or Mexican hat wavelet. For example, the continuous wavelet transform of the continuous spectrum x(λ) may be given by equation (1) below:

$${X}_{Ψ} ( s , λ ) = \frac{1}{\sqrt{a}} {\int }_{- ∞}^{∞} x ( ξ ) Ψ ( \frac{ξ - λ}{s} ) d ξ , \qquad ( 1 )$$

wherein
Ψ is the continuous wavelet and s is the scale parameter, wherein larger values of s correspond to wider, larger scale wavelets. These continuous wavelet functions work as a matched filter to look for features in the spectrum and can stretch to different widths, enabling the continuous wavelet transform to identify features at different scales.

The unnormalized continuous Haar wavelet at scale s can be applied at data processing module 205 on the interval [−s/2, s/2] by equation (2) below:

$${H}_{s}^{c} ( λ ) = \{ \begin{matrix}1 & if λ ∈ [ - s / 2 , 0 ) \\ - 1 & if λ ∈ [ 0 , s / 2 ] \\ 0 & otherwise\end{matrix} . \qquad ( 2 )$$

Embodiments herein may use it to find edges in the original spectrum by looking for edges in the sampled continuous wavelet transform data.

The continuous Mexican Hat wavelet can be defined by equation (3) below:

$$M ( λ ) = \frac{2}{\sqrt{3} {π}^{1 / 4}} ( 1 - λ ) {e}^{- {λ}^{2} / 2} . \qquad ( 3 )$$

wherein
the continuous Mexican Hat wavelet is the negative normalized second derivative of the Gaussian and is a peak finding wavelet. Embodiments herein may use it to find peaks in the original spectrum by looking for peaks in the sampled continuous wavelet transform data.

In some embodiments, data processing module 205 may apply a discretized form of the continuous wavelet transform shown in equation (1). To compute the discretized continuous wavelet transformation, a sampled form of equation (1) may be used as given by equation (4) below:

$${X}_{Ψ} ( s , i ) = {\sum }_{j = - n}^{n} {Ψ}_{s} ( j ) x ( i + j ) \qquad ( 4 )$$

wherein
x(i) is a sampled spectral data and Ψₛ is a discretization of the scale s wavelet. The discretized continuous wavelet transform may be computed on the two sampled input spectral data at 305, respectively. The discrete wavelet may be a discrete Haar wavelet, a centered version of the discrete Haar wavelet, a discrete Mexican hat wavelet, or any other discrete wavelet function. These discrete wavelet functions also work as a matched filter to look for features in the sampled spectrum and can stretch to different widths, enabling the discretized continuous wavelet transform to identify features at different scales.

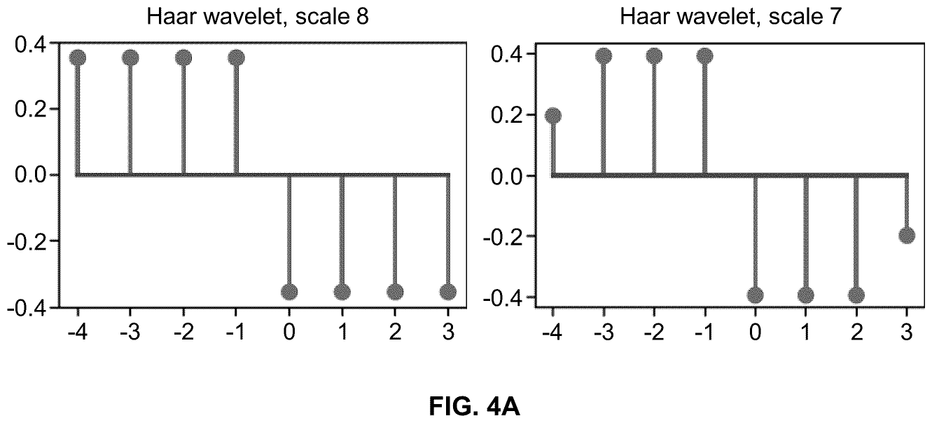

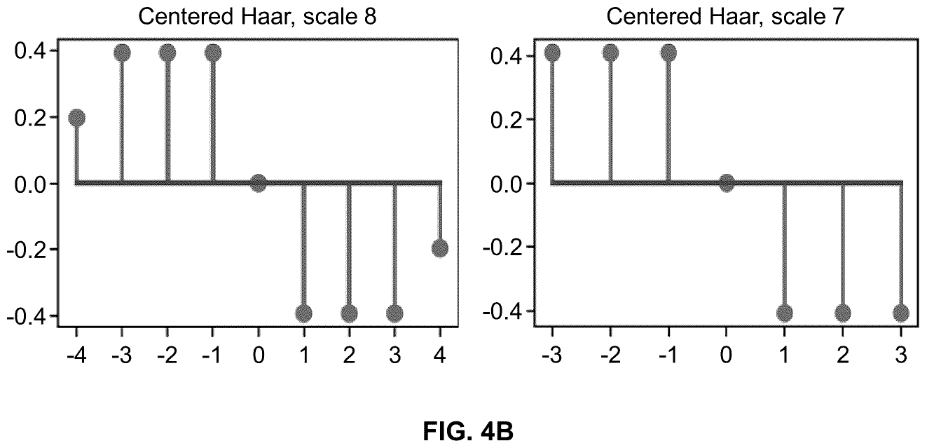

FIG. 4A is the discrete Haar wavelet at scales 7 and 8, respectively, according to some embodiments. The discrete Haar wavelet can be obtained at data processing module 205 by integrating

$${H}_{s}^{c}$$

over intervals [i, i+1], where i is an integer, resulting in definition by equation (5) below:

$${H}_{s} ( j ) = {C}_{s} \{ \begin{matrix}frac ( s / 2 ) , & if j = - ⌊ s / 2 ⌋ - 1 \\ 1 , & if - ⌊ s / 2 ⌋ \leq j < 0 \\ - 1 , & if 0 \leq j \leq ⌊ s / 2 ⌋ - 1 \\ - frac ( s / 2 ) , & if j = ⌊ s / 2 ⌋ \\ 0 & otherwise\end{matrix} , \qquad ( 5 )$$

wherein
frac (x)=x−└x┘ is the fractional part of x, the scale, s, is the full width of the original continuous wavelet, and Cₛ is a constant chosen so that ∥Hₛ∥₂=1. When s is an even integer, ±s/2 is an integer so

$${H}_{s}^{c}$$

is constant on [i, i+1]. This means that when s is even, the discrete wavelet has s/2 positive equal values followed by s/2 negative equal values. When s is not even, or not an integer, the outermost intervals are partly covered by

$${H}_{s}^{c} ,$$

resulting in a smaller value at each end. If s<=2 then the continuous wavelet falls entirely within the interval [−1, 1] and as a result, it will have only two nonzero values. After normalization by Cₛ those two values will be ±1/\sqrt{2}, so all of the discrete Haar wavelets are equal when s<=2. The discrete Haar wavelet can be used to find spectral features by looking for zero crossings in the sampled continuous wavelet transform data.

FIG. 4B is the discrete centered Haar wavelet at scales 7 and 8, respectively, according to some embodiments. The centered version of the sampled Haar wavelet can be defined at data processing module 205 by integrating

$${H}_{s}^{c}$$

on intervals [i, i+1]. To form a centered wavelet, embodiments herein may instead integrate on intervals [i−½, i+½], which gives definition by equation (6) below:

$${H}_{s}^{c} ( j ) = {C}_{s}^{c} \{ \begin{matrix}frac ( \frac{1}{2} ( s - 1 ) ) , & if j = - ⌊ \frac{1}{2} ( s - 1 ) ⌋ - 1 \\ 1 , & if - ⌊ \frac{1}{2} ( s - 1 ) ⌋ \leq j \leq - 1 \\ 0 , & if j = 0 \\ - 1 , & if 1 \leq j \leq ⌊ \frac{1}{2} ( s - 1 ) ⌋ \\ - frac ( \frac{1}{2} ( s - 1 ) ) , & if j = ⌊ \frac{1}{2} ( s - 1 ) ⌋ + 1\end{matrix} \qquad ( 6 )$$

wherein
this sampled wavelet is zero at the center, so it may ignore the center point, and when s≤2 it is identically zero, enabling to use it for scales larger than 2.

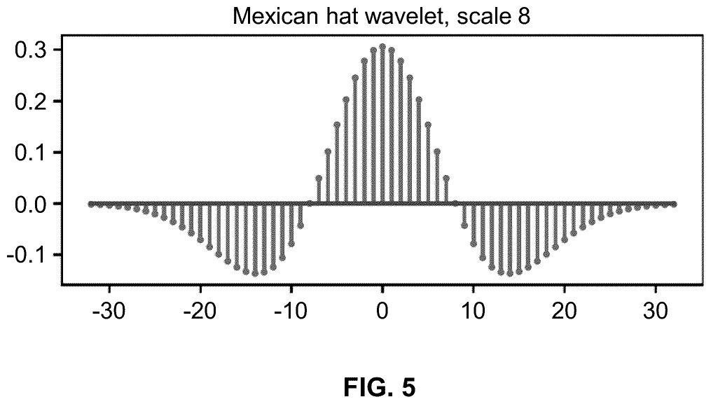

FIG. 5 is an example discrete Mexican hat wavelet at scale 8, according to some embodiments. The discrete Mexican hat wavelet can be obtained at data processing module 205 by integrating over centered intervals [i−½, i+½], which gives definition by equation (7) below:

$$\begin{matrix}{M}_{s} ( i ) & = {\int }_{i - 1 / 2}^{i + 1 / 2} M ( λ ) d λ \\ & {= \frac{2}{\sqrt{3 s} {π}^{1 / 4}} λ {e}^{- {λ}^{2} / 2 {s}^{2}} ]}_{i - 1 / 2}^{i + 1 / 2}\end{matrix} . \qquad ( 7 )$$

wherein
the integral of M is simply the negative first derivative of the Gaussian, with suitable normalization factors applied. This wavelet has unbounded support, some embodiments may clip off the wavelet somewhere to improve the computational speed. The width of the peak of the wavelet is 2s and to capture the two side lobes, embodiments herein can retain the points in the interval [−4s, 4s], which means that a scale s wavelet has 8s+1 points. This may be more points than needed. If no further normalization occurs, the 2-norm of the wavelet is slightly below 1 due to the missing part of the curve outside the interval [−4s, 4s].

Once a wavelet is selected, the sampled continuous wavelet transform can be computed at a particular scale by scaling the wavelet to that scale and convolving it with a spectrum. If end effects occur in the convolution, they can be handled by padding the ends of the spectrum with copies of its left-most and right-most value.

At 310, feature extraction module 210, for each scale of the plurality of scales, first extracts first spectral features from the first wavelet transform data from 305 at the respective scale and second spectral features from the second wavelet transform data from 305 at the respective scale. As would be appreciated by a person of ordinary skill in the art, feature extraction module 210 may extract the spectral features from other transformed data obtained from data processing module 205.

In some embodiments, feature extraction module 210 may be performed on different scales associated with the wavelet transform data. Embodiments herein can use, but are not limited to, four approaches for extracting features. These approaches will work because the smoothing provided by the wavelet transform at 305 will make feature finding robust.

In some embodiments, at 310, feature extraction module 210 may extract the features using an approach termed as peakfind. The approach peakfind can search for peak features in the wavelet transformed data. If the data was transformed using the Mexican hat wavelet or some other peak finding wavelet then the located peaks correspond to peaks in the original spectral data. This approach can involve declaring a point to be a peak if that point is the maximum value on a window centered at the point. The default window width can be 3. When the window extends off the edge of the data, the peak may be calculated based only on the overlapping part. The peakfind approach can also not allow the first or last points in a spectrum to be identified as extrema.

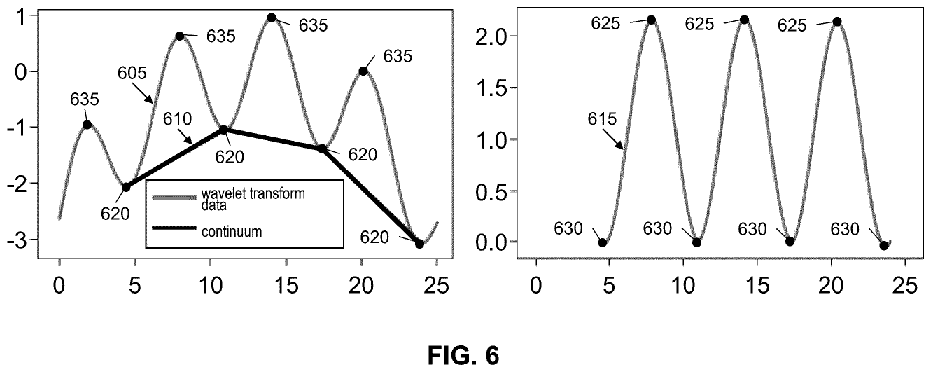

FIG. 6 shows an example illustrating the peakfind-cr, according to some embodiments. For simplicity, only some of the peak or valley centers may be labeled. In some embodiments, at 310, feature extraction module 210 may extract the spectral features using peakfind-cr. The approach peakfind-cr can use ordinary approach peakfind to locate peak features (e.g., 635 in FIG. 6) but then can adjust these peak feature positions by performing a continuum removal. For example, this approach can happen to the wavelet transformed data 605. For a given peak the approach can define the lower linear continuum 610 by interpolating among the adjacent valleys 620. The approach can also subtract this lower continuum 610 from the wavelet transformed data 605, producing the continuum removed data 615. The approach can obtain the adjusted peak centers 625 from the continuum removed data 615. For locating adjusted valley feature centers 630 in the continuum removed data 615, the approach can also apply the analogous process comprising: 1) defining a linear upper continuum 610; 2) subtracting it from the wavelet transformed data 605; and 3) recomputing the valley centers. When the window extends off the edge of the wavelet transformed data, the approach may not define the continuum and may not adjust the position of the last peak or valley at either end of the data.

In some embodiments, at 310, feature extraction module 210 may extract the spectral features using an approach termed as zerofind. The approach zerofind can find the zero crossing features in the data. The zero crossings in the Haar wavelet transform correspond to peaks and valleys in the original spectral data. The approach can use the slope at the crossing to determine the extremum type. If the sign of xᵢ₋₁ is not equal to the sign of xᵢ, then a zero crossing appears somewhere in the interval [i−1, i] and the slope is m=xᵢ₋₁−xᵢ. The approach can estimate the zero's position using linear interpolation as i−1+|xᵢ₋₁/m|. The sign of m distinguishes between peaks and valleys. Special cases arise if x(i−1)=0. If the zero falls on the first point (i=0) or the last point, it may be discarded. The approach can compute the slope as m=(xᵢ−xᵢ₋₂)/2, wherein the approach can compute the slope based on the two neighbors of the zero as xᵢ−xᵢ₋₂. If this slope is zero, the approach can also discard the point. If the data contains consecutive zeros only the first and last may be reported. If the consecutive zeros form a plateau then the plateau edges may be reported as a peak-valley pair; otherwise when the data form a flat inflection region, the edges may be reported as consecutive peaks or valleys.

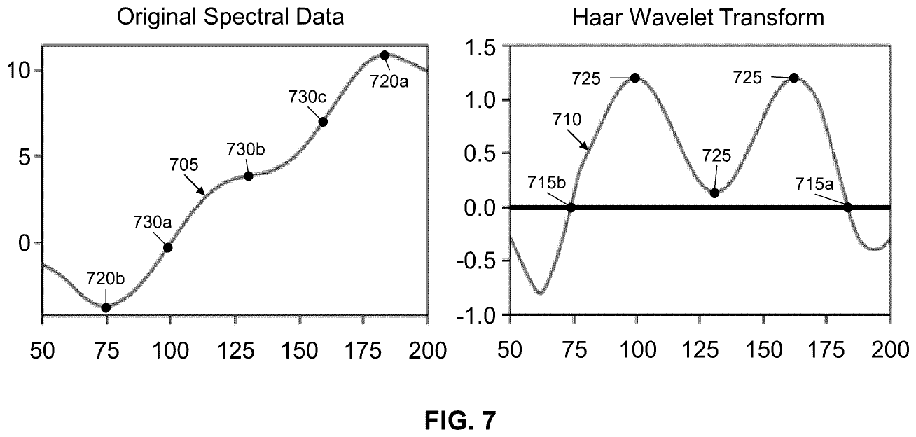

FIG. 7 shows an example illustrating the approach peakinflection, according to some embodiments. For simplicity, only some of the peak or valley centers may be labeled. In some embodiments, at 310, feature extraction module 210 may extract the spectral features using peakinflection. The approach peakinflection is designed to find inflection point features in the wavelet transformed data 710 that are actually peaks (e.g., 725 in FIG. 7) which are hidden by a non-constant offset. This approach can operate on Haar wavelet transformed data 710 and can use zerofind approach in wavelet transformed data 710 by finding zero crossings 715a and 715b to locate peaks 720a and valleys 720b for the original spectral data 705. This approach can then look for extrema 725 in the wavelet transformed data 710, which may correspond to inflection points 730a, 730b, and 730c in the original spectral data 705. A regular peak adjacent to a regular valley may have one inflection point in between. If three inflection points appear it could be the case of interest, where a peak-valley pair may have been hidden by addition of perhaps a linear offset. When three inflection points 730a, 730b, and 730c appear, the approach can interpret them as two features, a peak for 730a and a valley for 730c, co-located at the position of the central inflection point 730b. This may make it possible for the spectrum to match successfully against a spectrum where the two features appear distinctly. If two pairs of peaks are “lost” then they can give rise to 5 inflection points (e.g., two sets of three that share one point). The approach can ignore a single isolated inflection point. When the approach finds a run of inflections, it can return a pair of peaks for every second inflection on the list.

At 315, feature extraction module 210, for each scale of the plurality of scales, second extracts the first feature strength values from the first spectral features from 310 and second feature strength values from the second spectral features from 310. Embodiments herein can utilize, but are not limited to, several approaches for calculating the feature strength value of a feature, wherein the feature strength values can be used for scoring feature mismatches.

In some embodiments, at 315, feature extraction module 210 may set the feature strength values using an approach termed as one. This approach may set the feature strength values of the spectral features to constant one so this approach is feature independent.

In some embodiments, at 315, feature extraction module 210 may set the feature strength values using an approach termed as height. This approach may set the feature strength value as an average change in height of the spectrum, wherein the averaged change is computed by comparing the height at the feature to the height at the adjacent features on either side. At the edges of the data, the approach can determine height from just one adjacent feature. When the whole spectrum contains only one feature, the approach can use the start and end points of the data for computing its height.

In some embodiments, at 315, feature extraction module 210 may set the feature strength values using an approach termed as value. This approach may set the feature strength value as an absolute value of the wavelet transform data at a feature location. This approach may use linear interpolation for feature strength values at non-integer feature locations.

In some embodiments, at 315, feature extraction module 210 may set the feature strength values using an approach termed as width. This approach may set the feature strength value as the width of the feature, wherein the width is computed by finding the adjacent features on each side and counting the number of bands between them. For wavelet transform data at the ends with only one adjacent feature, the approach can return twice the distance to that feature. When there are no neighbors of a feature, the approach can return the width of the entire data.

In some embodiments, at 315, feature extraction module 210 may set the feature strength values using an approach termed as area. This approach may set the feature strength value as an area of the feature, wherein the area is computed by finding the adjacent features on each side and computing the sum of the absolute value of the wavelet transform data between those two adjacent features. If there is no adjacent feature, then the approach may use the edge of the data. If the data is the derivative of the original spectrum, as is the case for Haar wavelet transformed data, then this approach involves integrating that derivative, which may recover the values of the original spectrum. Because of the use of the absolute value and the integration between adjacent features, this calculation may result in computing the sum of the change in height between the feature and the two adjacent features.

In some embodiments, at 315, feature extraction module 210 may set the feature strength value as a quotient of any two items from the list above. The default feature strength value for the Mexican hat wavelet, for example, is height divided by width. The Mexican hat can be a peak detecting wavelet and the approach can expect the height and width of the feature in the wavelet to correspond to height and width of the feature in the wavelet transform data. The most decisive features are often those which are narrow and tall, which may be captured by this definition. The default for the Haar wavelet can be an area divided by a width. Since the Haar wavelet is a derivative operator, the approach can expect area to correspond to the height of features in the wavelet transform data, so this choice can be equivalent to the choice for the Mexican hat.

At 320, distance calculation module 215, for each scale of the plurality of scales, determines, based on the first spectral features from 310, the second spectral features from 310, the first feature strength values from 315, and the second feature strength values from 315, an edit distance for the respective scale.

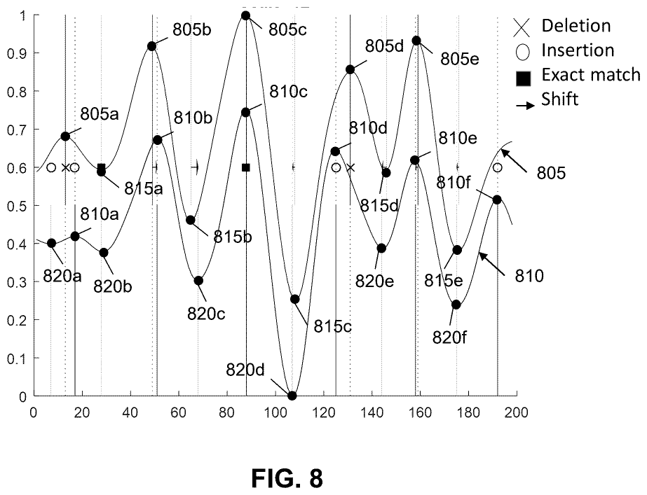

FIG. 8 illustrates a feature alignment example between two spectral features, according to some embodiments. For simplicity, only some of the peak or valley centers may be labeled. Embodiments herein can utilize, but are not limited to, the spectral features and feature strength values at different scales using the approaches described above. Embodiments herein may also identify how similar or different two lists of spectral features are. In order to do this, some embodiments can use an edit distance, which computes the minimum cost to transform one plurality of spectral features into the other one by retrieving operations comprising deleting features, inserting features, or shifting features. For example, the spectra data 805 and 810 can be obtained after performing continuous wavelet transform to the two input spectral data, respectively. The 805a, 805b, 805c, 805d, and 805e are extracted peak features from the spectra data 805. The 810a, 810b, 810c, 810d, 810e, and 810f are extracted peak features from the spectra data 810. The 815a, 815b, 815c, 815d, and 815e are extracted valley features from the spectra data 805. The 810a, 810b, 810c, 810d, 810e, and 810f are extracted peak features from the spectra data 810. The 820a, 820b, 820c, 820d, 820e, and 820f are extracted valley features from the spectra data 810. In this example, the minimum cost to transform spectra data 805 to 810 includes deleting features 805a, 805d, inserting features 820a, 810a, 810d, 810f, and shifting features 805b, 815b, 815c, 815d, 805e, 815e.

In some embodiments, at 320, distance calculation module 215 may assign a cost to each of these operations. It can penalize deletions and insertions of features using the feature strength values. This option is a symmetric option because distance calculation module 215 may assign the same score to both insertions and deletions at 320. Embodiments herein may also use an asymmetric option, where at 320, distance calculation module 215 may allow free insertions rather than penalizing them like deletions. This means that a good match can occur when the imaged spectrum has the corresponding features in the library spectrum even if it may have some extra features, but if the measured spectrum lacks features that appear in the library spectrum then it can be penalized.

In some embodiments, at 320, distance calculation module 215 can assign a cost associated with aligning two features with a feature shift. For example, suppose a peak or valley feature in the first spectrum occurs at wavelength, λ₁, and the corresponding peak or valley feature in the second spectrum occurs at λ₂. If one feature is a valley and the other feature is a peak then these features cannot be aligned with each other, so at 320, distance calculation module 215 can assign infinite cost in this case to prevent the features from aligning—it can be cheaper to insert or delete peaks instead. Otherwise, at 320, distance calculation module 215 can set the cost to α(λ₁−λ₂)² max (h₁, h₂), where h₁ and h₂ are the feature strength values of the two features, and a is a tunable parameter with units of μm⁻². The a parameter can adjust the relative weighting of the shift penalty to the deletion/insertion penalty. In some embodiments, the shift distance, |λ₁−λ₂|, can be converted from bands to wavelength using a constant bin width factor.

In some embodiments, the edit distance computed at distance calculation module 215 at scale s is the lowest cost that accounts for the features found at scale s in both spectra, treating them either as shifts, deletions and/or insertions. For example, let S be the set of wavelength pairs corresponding to shifts in the optimal feature alignment; let D be the set of wavelengths of features deleted from the first spectrum; let I be the set of wavelengths of features inserted into the first spectrum. Then the edit distance between the two spectra at scale s can be represented by equation (8) below.

$${d}_{s} = {\sum }_{( {λ}_{λ} , {λ}_{λ} ) ∈ 𝒮} α {( {λ}_{1} - {λ}_{2} )}^{2} max ( {h}_{1} , {h}_{2} ) + {\sum }_{{λ}_{1} ∈ 𝒟} {h}_{1} + {\sum }_{{λ}_{2} ∈ ℐ} {h}_{2} \qquad ( 8 )$$

wherein
h₁ is the feature strength value of a feature in the first spectrum and h₂ is the feature strength value of a feature in the second spectrum. For the asymmetric case, the term involving I does not appear, since insertions are free. Given a set of scales, S, edit distances can be computed as described above to obtain a set of distance values at the corresponding scales, {dₛ|sϵS}.

At 325, distance calculation module 215 calculates, based on the edit distance for each scale of the plurality of scales from 320, a feature edit distance score indicating the spectral data similarity between the first spectral data and the second spectral data. However, when the number of features is larger the edit distance at one scale tends to be larger. Typically, spectra have more features at smaller scales, so if combining the dₛ values directly, at 325, distance calculation module 215 may give more weight to small scales. Embodiments herein may use, but are not limited to, two types of normalization to correct this imbalance between different scales-count normalization and maxcost normalization.

In some embodiments, at 325, distance calculation module 215 can use a count normalization. The count normalization may define a normalization factor at each scale by setting fₛ to the average number of features in the two spectra or, when insertions are free, the number of features in the library spectrum. Then the count normalized edit distance is dₛ/fₛ.

In some embodiments, at 325, distance calculation module 215 can use a maxcost normalization. The maxcost normalization may define a maxcost normalized distance that can attain the value 0 if the spectra share all their features (or all the library features in the asymmetric case), and 1 if the spectra have no features in common. For example, let cₛ be the cost of deleting features at scale s from the first spectrum plus the cost of inserting features from the second spectrum at scale s, the value cₛ can be an upper bound on the edit distance, hence dₛ/cₛ lies in the interval [0, 1]. The maxcost normalized edit distance is dₛ/cₛ. This rescaling can interpret the meaning of the edit distance in an easier manner, and it can also enable comparing feature edit distance scores between different cases.

In some embodiments, the single feature edit distance score may be calculated at distance calculation module 215 by taking the L₂-norm of the normalized distances for some set of scales with equal weighting, as shown in equation (9) below.

$$d = \sqrt{{\sum }_{s ∈ 𝒮} {( {d}_{s}^{*} )}^{2}} . \qquad ( 9 )$$

Where, let d*ₛ is the normalized distance at scale s, wherein d*ₛ can be equal to dₛ/fₛ for count normalization or equal to dₛ/cₛ for maxcost normalization. As would be appreciated by a person of ordinary skill in the art, embodiments herein may use other distance measures including but not limited to L₁-norm to calculate the single feature edit distance score.

In some embodiments, plot construction module 220 may construct a spectral disagreement plot. The spectral disagreement plot may help to identify which spectral bands are responsible for the feature edit distance scores. Embodiments herein may construct, but are not limited to, a band weighting measure which assigns a score to each band according to how much it elevates the edit distance at a particular scale. The edit distance at a single scale can be the sum of contributions corresponding to the features in one or both of the spectra. The band weighting may work using a heuristic estimate for the contribution due to the features at a given scale. For a scale, it can yield a plot of the contribution of the bands toward the final distance value.

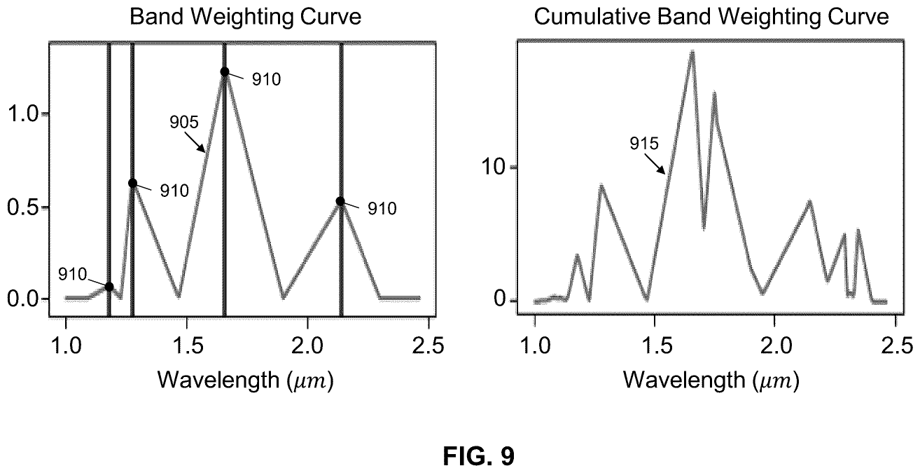

FIG. 9 shows an example illustrating the construction of band weighting curve, according to some embodiments. In some embodiments, plot construction module 220 can begin with the list of spectral features and their associated feature edit distance score contribution to construct the band weighting curve. For a given spectral feature, plot construction module 220 can presume that the band at the peak center may make the largest contribution to its score, with neighboring bands contributing progressively less. To model this, embodiments herein can use a triangle whose peak is aligned with the feature centers 910. The full width of these features centers reaches half way to the adjacent features in each direction, or half way to the edge of the data if there is no adjacent features. A triangle function can be generated that has the shape of a triangle being zero for values below and/or above the adjacent features. The triangle function then forms a triangle with its peak at each feature center 910. The height of the triangle can be set equal to the feature edit distance score associated with the feature, where it takes a value equal to the cost in the edit distance of the feature, which may be either cost to insert it, cost to delete it, or the cost to shift. Assembling these triangles for the features at a single scale can produce the band weighting curve 905 for that scale. The band weighting curves for several scales may be added together to produce a cumulative band weighting curve shown in 915.

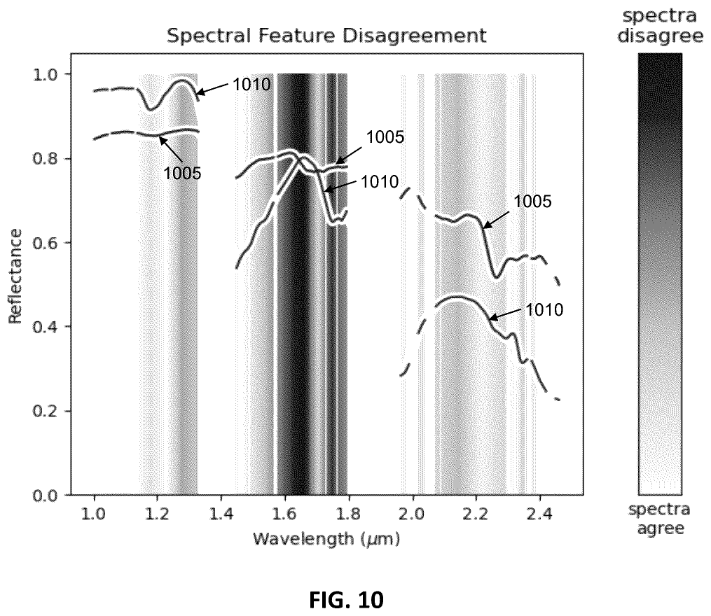

FIG. 10 shows an example of the Spectral Feature Disagreement plot illustrating the heat map representation of the cumulative band weighting plot, according to some embodiments. At FIG. 10, two spectral data being compared through the feature edit distance is labeled as 1005 and 1010, respectively. The darker band may indicate more contribution to the feature edit distance score and the lighter band may indicate less contribution. In some embodiments, plot construction module 220 may calculate band weighting at several scales. Plot construction module 220 can add the plots from different scales together to obtain a cumulative band weighting plot. For example, plot construction module 220 can construct the cumulative band weighting plot using a heat map representation.

The experiments have been conducted on every pair from the 468 spectra, a total of 219,024 cases, to validate the performance of spectral similarity measuring system. The experiments show the system performance by constructing a ROC curve. The area under the ROC curve can be a performance metric. A perfect detector will score 1 on this metric, and a random detector will score 0.5. The class sizes can vary considerably in the data set, so when computing the ROC curve a normalization by class size has been applied. The reference method is spectral fit, which may be defined for two spectra, x₁ and x₂, as shown in equation (13) below:

$$F ( {x}_{1} , {x}_{2} ) = \frac{{( {x}_{1} - {\overline{x}}_{1} )}^{T} ( {x}_{2} - {\overline{x}}_{2} )}{\vert {x}_{1} - {\overline{x}}_{1} \vert \vert {x}_{2} - {\overline{x}}_{2} \vert} , \qquad ( 13 )$$

wherein the bar indicates the mean value of the spectrum.

Table 1 lists the performance (the best ROC Area value for each system embodiment) of six embodiments of the spectral similarity measuring system, according to some embodiments. The feature edit distance calculation, according to different embodiments, can have many operating modes and parameters, e.g., wavelet function, feature extraction, and feature strength value. Some embodiments may not add a penalty to the insertions (e.g., asymmetric), but some embodiments may add a penalty to the insertions (e.g., symmetric). Also, as a reference method in Table 1, the spectral fit,

TABLE 1
System embodiments tested and their performance.

| system embodiments | | | ROC area | |
|---|---|---|---|---|
| wavelet | feature | feature | asym- | sym- |
| function | extraction | strength value | metric | metric |
| Mexhat | peakfind | height/width | 0.960 | 0.967 |
| Mexhat | peakfind-cr | height/width | 0.960 | |
| Haar | zerofind | area/width | 0.976 | 0.984 |
| Haar | peakfind | value/width | 0.920 | |
| Haar | peakinflection | area/width | 0.946 | |
| Haar centered | zerofind | area/width | 0.975 | |

| | |
|---|---|
| spectral fit (reference method) | 0.723 |

shows a ROC area of 0.723. ROC area can take values from 0 to 1. A higher ROC area (closer to 1) indicates better performance. A perfect model would have an ROC area of 1. The Table 1 shows that the Haar wavelet function with zerofind as feature extraction gives the best ROC area performance.

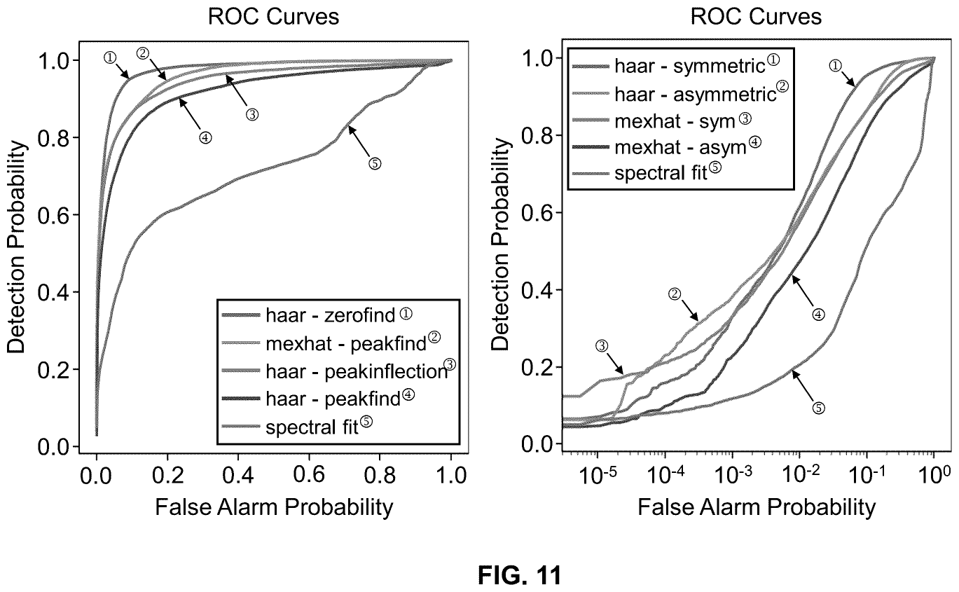

FIG. 11 shows ROC curves for some of the system embodiments with zero penalty for insertions (e.g., asymmetric), according to some embodiments. The embodiment with Haar as wavelet function and zerofind as feature extraction gives the best performance. All feature edit distance system embodiments perform better than the reference spectral fit.

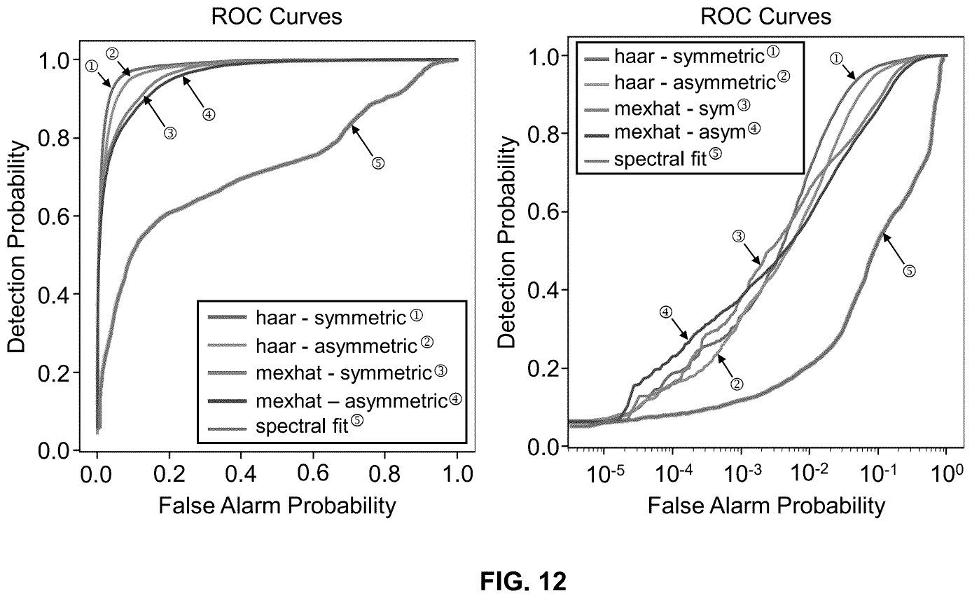

FIG. 12 shows ROC curves for some of the system embodiments with penalty for insertions appear (e.g., symmetric), according to some embodiments. The embodiment with the symmetric method gives the best performance for both Haar and Mexhat wavelet functions as shown by the improved ROC curves in each case.

Computer system 1300 may include one or more processors (also called central processing units, or CPUs), such as a processor 1304. Processor 1304 may be connected to a communication infrastructure or bus 1306.

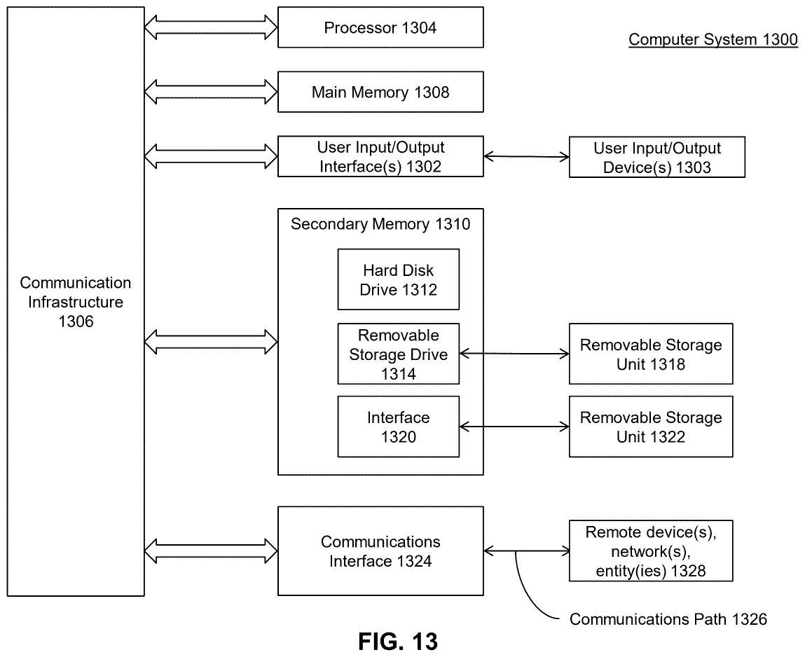

FIG. 13 illustrates an exemplary computer system capable of accessing spectral data similarity between two spectral data, according to one embodiment of the present disclosure. Various embodiments may be implemented, for example, using one or more well-known computer systems, such as computer system 1300 shown in FIG. 13. For example, embodiments herein computing data transform to spectral data at 305, extracting spectral features at 310, extracting feature strength values at 315, calculating edit distances at 320, and calculating feature edit distance score at 325 may be implemented using combinations or sub-combinations of computer system 1300. Also or alternatively, one or more computer systems 1300 may be used, for example, to implement any of the embodiments discussed herein, as well as combinations and sub-combinations thereof.

Computer system 1300 may include one or more processors (also called central processing units, or CPUs), such as a processor 1304. Processor 1304 may be connected to a communication infrastructure or bus 1306.

Computer system 1300 may also include user input/output device(s) 1303, such as monitors, keyboards, pointing devices, etc., which may communicate with communication infrastructure 1306 through user input/output interface(s) 1302.

One or more of processors 1304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1300 may also include a main or primary memory 1308, such as random access memory (RAM). Main memory 1308 may include one or more levels of cache. Main memory 1308 may have stored therein control logic (i.e., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1314 may be a floppy disk drive, a magnetic tape drive, a compact disk drive, an optical storage device, tape backup device, and/or any other storage device/drive.

Removable storage drive 1314 may interact with a removable storage unit 1318. Removable storage unit 1318 may include a computer usable or readable storage device having stored thereon computer software (control logic) and/or data. Removable storage unit 1318 may be a floppy disk, magnetic tape, compact disk, DVD, optical storage disk, and/any other computer data storage device. Removable storage drive 1314 may read from and/or write to removable storage unit 1318.

Secondary memory 1310 may include other means, devices, components, instrumentalities or other approaches for allowing computer programs and/or other instructions and/or data to be accessed by computer system 1300. Such means, devices, components, instrumentalities or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1300 may further include a communication or network interface 1324. Communication interface 1324 may enable computer system 1300 to communicate and interact with any combination of external devices, external networks, external entities, etc. (individually and collectively referenced by reference number 1328). For example, communication interface 1324 may allow computer system 1300 to communicate with external or remote devices 1328 over communications path 1326, which may be wired and/or wireless (or a combination thereof), and which may include any combination of LANs, WANs, the Internet, etc. Control logic and/or data may be transmitted to and from computer system 1300 via communication path 1326.

Computer system 1300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as computer system 1300 or processor(s) 1304), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for accessing a spectral data similarity between first spectral data and second spectral data, comprising:
for each scale of a plurality of scales:
applying, by at least one computer processor at a respective scale, a wavelet transform on the first spectral data and the second spectral data, thereby obtaining first wavelet transform data and second wavelet transform data at the respective scale, respectively;
first extracting first spectral features from the first wavelet transform data at the respective scale and second spectral features from the second wavelet transform data at the respective scale;
second extracting first feature strength values from the first spectral features and second feature strength values from the second spectral features;
determining, based on the first spectral features, the second spectral features, the first feature strength values, and the second feature strength values, an edit distance for the respective scale; and
calculating, based on the edit distance for each scale of the plurality of scales, a feature edit distance score indicating the spectral data similarity between the first spectral data and the second spectral data.

2. The computer-implemented method according to claim 1, further comprising performing at least one of:
inserting a skip sample to a gap associated with the first spectral data; or
interpolating a value to the gap associated with the first spectral data.

3. The computer-implemented method according to claim 1, wherein the applying comprises performing at least one of:
applying a continuous wavelet transform on the first spectral data; or
applying a discretized wavelet transform on the first spectral data.

4. The computer-implemented method according to claim 1, wherein the first extracting comprises:
locating a spectral feature on at least one of a peak position, a zero crossing position, or an inflection point position in the first wavelet transform data.

5. The computer-implemented method according to claim 1, wherein the second extracting comprises:
third extracting a feature strength value for a spectral feature in the first spectral features, wherein the third extracting comprises performing at least one of:
setting the feature strength value equal to one;
setting the feature strength value equal to an absolute value of the spectral feature;
setting the feature strength value equal to a height;
setting the feature strength value equal to a width;
setting the feature strength value equal to an area;
setting the feature strength value equal to one divided by the area;
setting the feature strength value equal to the absolute value divided by the height;
setting the feature strength value equal to the height divided by the width; or
setting the feature strength value equal to the area divided by the width.

6. The computer-implemented method according to claim 1, wherein the determining comprises:
computing a minimum cost value of transforming the first spectral features into the second spectral features based on a penalty associated with deleting a spectral feature from the first spectral features, inserting a spectral feature into the second spectral features, or shifting a spectral feature in the second spectral features.

7. The computer-implemented method according to claim 1, wherein the calculating comprises:
performing a count normalization or maxcost normalization to the edit distance for each scale of the plurality of scales, thereby producing a normalized version of the edit distance; and
calculating an L₂-norm based on the normalized version of each of the plurality of edit distances.

8. A system for accessing a spectral data similarity between first spectral data and second spectral data, comprising:
one or more memories;
at least one processor each coupled to at least one of the memories and configured to perform operations comprising:
for each scale of a plurality of scales:
applying, at a respective scale, a wavelet transform on the first spectral data and the second spectral data, thereby obtaining first wavelet transform data and second wavelet transform data at the respective scale, respectively;
first extracting first spectral features from the first wavelet transform data at the respective scale and second spectral features from the second wavelet transform data at the respective scale;
second extracting first feature strength values from the first spectral features and second feature strength values from the second spectral features;
determining, based on the first spectral features, the second spectral features, the first feature strength values, and the second feature strength values, an edit distance for the respective scale; and
calculating, based on the edit distance for each scale of the plurality of scales, a feature edit distance score indicating the spectral data similarity between the first spectral data and the second spectral data.

9. The system according to claim 8, wherein the operations further comprise performing at least one of:
inserting a skip sample to a gap associated with the first spectral data; or
interpolating a value to the gap associated with the first spectral data.

10. The system according to claim 8, wherein the applying comprises performing at least one of:
applying a continuous wavelet transform on the first spectral data; or
applying a discretized wavelet transform on the first spectral data.

11. The system according to claim 8, wherein the first extracting comprises:
locating a spectral feature on at least one of a peak position, a zero crossing position, or an inflection point position in the first wavelet transform data.

12. The system according to claim 8, wherein the second extracting comprises:
third extracting a feature strength value for a spectral feature in the first spectral features, wherein the third extracting comprises performing at least one of:
setting the feature strength value equal to one;
setting the feature strength value equal to an absolute value of the spectral feature;
setting the feature strength value equal to a height;
setting the feature strength value equal to a width;
setting the feature strength value equal to an area;
setting the feature strength value equal to one divided by the area;
setting the feature strength value equal to the absolute value divided by the height;
setting the feature strength value equal to the height divided by the width; or
setting the feature strength value equal to the area divided by the width.

13. The system according to claim 8, wherein the determining comprises:
computing a minimum cost value of transforming the first spectral features into the second spectral features based on a penalty associated with deleting a spectral feature from the first spectral features, inserting a spectral feature into the second spectral features, or shifting a spectral feature in the second spectral features.

14. The system according to claim 8, wherein the calculating comprises:
performing a count normalization or maxcost normalization to the edit distance for each scale of the plurality of scales, thereby producing a normalized version of the edit distance; and
calculating an L₂-norm based on the normalized version of each of the plurality of edit distances.

15. A non-transitory computer-readable medium having instructions stored thereon that, when executed by at least one computing device, cause the at least one computing device to perform operations comprising:
for each scale of a plurality of scales:
applying, at a respective scale, a wavelet transform on the first spectral data and the second spectral data, thereby obtaining first wavelet transform data and second wavelet transform data at the respective scale, respectively;
first extracting first spectral features from the first wavelet transform data at the respective scale and second spectral features from the second wavelet transform data at the respective scale;
second extracting first feature strength values from the first spectral features and second feature strength values from the second spectral features;
determining, based on the first spectral features, the second spectral features, the first feature strength values, and the second feature strength values, an edit distance for the respective scale; and
calculating, based on the edit distance for each scale of the plurality of scales, a feature edit distance score indicating the spectral data similarity between the first spectral data and the second spectral data.

16. The non-transitory computer-readable medium according to claim 15, wherein the applying comprises performing at least one of:
applying a continuous wavelet transform on the first spectral data; or
applying a discretized wavelet transform on the first spectral data.

17. The non-transitory computer-readable medium according to claim 15, wherein the first extracting comprises:
locating a spectral feature on at least one of a peak position, a zero crossing position, or an inflection point position in the first wavelet transform data.

18. The non-transitory computer-readable medium according to claim 15, wherein the second extracting comprises:
third extracting a feature strength value for a spectral feature in the first spectral features wherein the third extracting comprises performing at least one of:
setting the feature strength value equal to one;
setting the feature strength value equal to an absolute value of the spectral feature;
setting the feature strength value equal to a height;
setting the feature strength value equal to a width;
setting the feature strength value equal to an area;
setting the feature strength value equal to one divided by the area;
setting the feature strength value equal to the absolute value divided by the height;
setting the feature strength value equal to the height divided by the width; or
setting the feature strength value equal to the area divided by the width.

19. The non-transitory computer-readable medium according to claim 15, wherein the determining comprises:
computing a minimum cost value of transforming the first spectral features into the second spectral features based on a penalty associated with deleting a spectral feature from the first spectral features, inserting a spectral feature into the second spectral features, or shifting a spectral feature in the second spectral features.

20. The non-transitory computer-readable medium according to claim 15, wherein the calculating comprises:
performing a count normalization or maxcost normalization to the edit distance for each scale of the plurality of scales, thereby producing a normalized version of the edit distance; and
calculating an L₂-norm based on the normalized version of each of the plurality of edit distances.
